(19) United States
(12) Patent Application Publication
(10) Pub. No.: US 2012/0108176 A1
(43) Pub. Date: May 3, 2012

(54) APPARATUS, SYSTEM, AND METHOD FOR OPTIMIZING MOBILE WIRELESS COMMUNICATIONS

(76) Inventor: Richard THAYER, Powhatan, VA (US)

(21) Appl. No.: 12/913,533

(22) Filed: Oct. 27, 2010

(51) Int. Cl. H04B 17/00

(52) U.S. Cl. 455/67.11

(57) ABSTRACT

According to at least one exemplary embodiment, a method for optimizing mobile wireless communications is disclosed. The method may include receiving a first communications signal from a first wireless network provider, receiving at least one additional communications signal from at least one additional network provider, executing a comparison between the first communication signal and the at least one additional communications signal, selecting one of the first communication signal and the at least one additional communications signal based on the comparison, and establishing a communications link to the selected signal.

### BACKGROUND

Wireless communication technology, including technology to facilitate wireless internet access has been introduced on a variety of mobile vehicles, for example, on buses, trains, and other forms of transport. However, providers of wireless internet services typically are not able to provide uniform signal quality across their coverage area, and, therefore, wireless reception and signal quality may deteriorate in certain areas. Furthermore, the coverage areas of wireless internet service providers have gaps and areas without any coverage at all. As mobile vehicles may repeatedly pass through such areas of poor or no coverage, users may be faced with repeated instances of suboptimal connection speeds and complete losses of connectivity as the mobile vehicle moves along its route. This, in turn, can lead to frustration on part of the user, as well as dissatisfaction with the operator of the mobile vehicle service. Such issues may also disproportionally affect operators whose mobile vehicles pass through rural areas, where wireless coverage is frequently not uniform and spotty.

Wireless coverage is typically provided to a user via a wireless modem, a router, and a wireless access point, wherein the modem is communicatively coupled to a wireless service provider, while the wireless access point provides a local network that may be accessed by a user's computer or other wireless-capable device. Typically, the local network, and the devices that access it, need to be compliant with the IEEE 802.11 standard. However, the range of an IEEE 802.11-compliant local network is typically limited, and may not encompass the entire interior of a larger mobile vehicle. Wireless repeaters can be utilized so as to extend such a network's range; however, such repeaters typically utilize directional antennas. In an articulated mobile vehicle, the use of directional antennas can lead to interruptions in the extended local network when the articulated vehicle is executing a turn or passing through a curve.

### SUMMARY

According to at least one exemplary embodiment, a method for optimizing mobile wireless communications is disclosed. The method may include receiving a first communications signal from a first wireless network provider, receiving at least one additional communications signal from at least one additional network provider, executing a comparison between the first communication signal and the at least one additional communications signal, selecting one of the first communication signal and the at least one additional communications signal based on the comparison, and establishing a communications link to the selected signal.

The method may further include monitoring the selected signal, comparing the selected signal to at least one additional communications signal from at least one additional network provider executing a comparison between the selected communication signal and the at least one additional communications signal, and establishing a communications link to one of the selected signal and the at least one additional communications signal.

According to another exemplary embodiment, a system for optimizing mobile wireless communications is disclosed. The system may include a processor, a routing and network selection device, at least one communications device coupled to the routing and network selection device, the at least one communications device capable of connecting to a wireless network provider and receiving a wireless communications signal from the wireless network provider, and at least one antenna coupled to the routing and network selection device, the at least one antenna capable of creating and maintaining a local area network.

The system may further include at least two communications devices coupled to the routing and network selection device, the at least two communications devices capable of connecting to at least two wireless network providers and receiving at least two wireless communications signal from the at least two wireless network providers, and logic adapted to execute a comparison between the at least two wireless communications signals, and to select one of the at least two wireless communications signals based on the comparison.

### BRIEF DESCRIPTION OF THE FIGURES

FIG. 1 is an exemplary diagram showing a computer system.

FIG. 2 is an exemplary diagram showing a routing and network selection device of a system for optimizing mobile wireless communications.

FIG. 3 is an exemplary diagram showing a wireless module of a system for optimizing mobile wireless communications.

FIG. 4 is an exemplary diagram showing a SBC board for a wireless module of a system for optimizing mobile wireless communications.

FIG. 5a shows an exemplary embodiment of a system for optimizing mobile communications being used in a vehicle.

FIG. 5b shows an exemplary embodiment of a system for optimizing mobile communications being used in an articulated vehicle.

FIG. 5c shows an exemplary embodiment of a system for optimizing mobile communications being used in a multiple-car articulated vehicle.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the teems “embodiments of the invention”, “embodiments” or “invention” do not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, “a computer configured to” perform the described action.

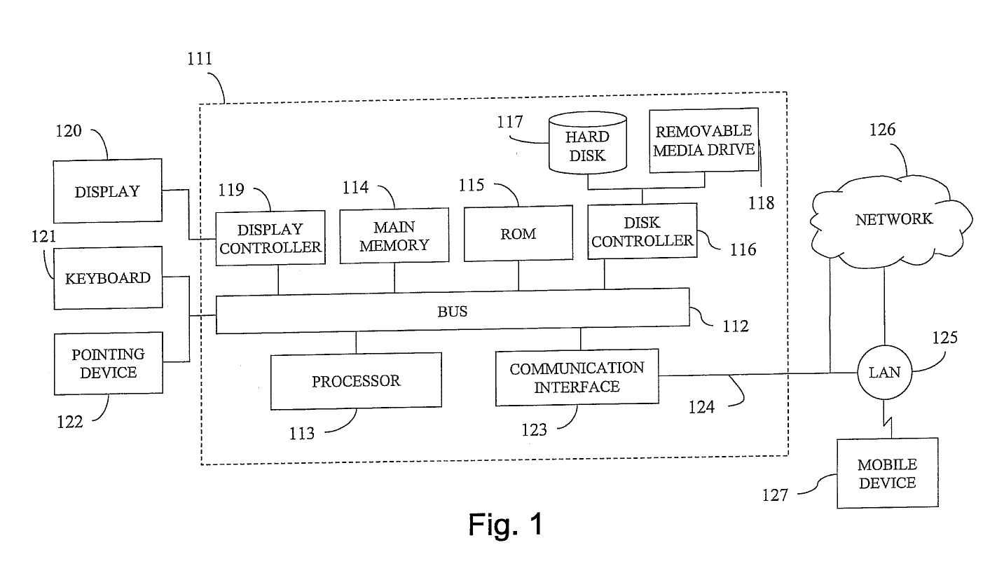

FIG. 1 illustrates a computer system 111 upon which an embodiment of the present invention may be implemented. The computer system 111 includes a bus 112 or other communication mechanism for communicating information, and a processor 113 coupled with the bus 112 for processing the information. The computer system 111 also includes a main memory 114, such as a random access memory (RAM) or other dynamic storage device (e.g., dynamic RAM (DRAM), static RAM (SRAM), and synchronous DRAM (SDRAM)), coupled to the bus 112 for storing information and instructions to be executed by processor 113. In addition, the main memory 114 may be used for storing temporary variables or other intermediate information during the execution of instructions by the processor 113. The computer system 111 further includes a read only memory (ROM) 115 or other static storage device (e.g., programmable ROM (PROM), erasable PROM (EPROM), and electrically erasable PROM (EEPROM)) coupled to the bus 112 for storing static information and instructions for the processor 113.

The computer system 111 also includes a disk controller 116 coupled to the bus 112 to control one or more storage devices for storing information and instructions, such as a magnetic hard disk 117, and a removable media drive 118 (e.g., floppy disk drive, read-only compact disc drive, read/write compact disc drive, compact disc jukebox, tape drive, and removable magneto-optical drive). The storage devices may be added to the computer system 111 using an appropriate device interface (e.g., small computer system interface (SCSI), integrated device electronics (IDE), enhanced-IDE (E-IDE), direct memory access (DMA), or ultra-DMA).

Further, exemplary embodiments include or incorporate at least one database which may store software, descriptive data, system data, digital images and any other data item required by the other components necessary to effectuate any embodiment of the present system known to one having ordinary skill in the art. The database may be provided, for example, as a database management system (DBMS), a relational database management system (e.g., DB2, ACCESS, etc.), an object-oriented database management system (ODBMS), a file system or another conventional database package as a few non-limiting examples. The database can be accessed via a Structure Query Language (SQL) or other tools known to one having skill in the art.

Still referring to FIG. 1, the computer system 111 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 111 may also include a display controller 119 coupled to the bus 112 to control a display 120, such as a cathode ray tube (CRT), liquid crystal display (LCD) or any other type of display, for displaying information to a computer client 204. The computer system includes input devices, such as a keyboard 121 and a pointing device 122, for interacting with a computer client 204 and providing information to the processor 113. Additionally, a touch screen could be employed in conjunction with display 120. The pointing device 122, for example, may be a mouse, a trackball, or a pointing stick for communicating direction information and command selections to the processor 113 and for controlling cursor movement on the display 120. In addition, a printer may provide printed listings of data stored and/or generated by the computer system 111.

The computer system 111 performs a portion or all of the processing steps of the invention in response to the processor 113 executing one or more sequences of one or more instructions contained in a memory, such as the main memory 114. Such instructions may be read into the main memory 114 from another computer readable medium, such as a hard disk 117 or a removable media drive 118. One or more processors in a multi-processing arrangement may also be employed to execute the sequences of instructions contained in main memory 114. In alternative embodiments, hard-wired circuitry may be used in place of or in combination with software instructions. Thus, embodiments are not limited to any specific combination of hardware circuitry and software.

As stated above, the computer system 111 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 111, for driving a device or devices for implementing the invention, and for enabling the computer system 111 to interact with a human client 204. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 113 for execution. A computer readable medium may take many forms, including but not limited to, non-volatile media, volatile media, and transmission media. Non-volatile media includes, for example, optical, magnetic disks, and magneto-optical disks, such as the hard disk 117 or the removable media drive 118. Volatile media includes dynamic memory, such as the main memory 114. Transmission media includes coaxial cables, copper wire and fiber optics, including the wires that make up the bus 112. Transmission media also may also take the form of acoustic or light waves, such as those generated during radio wave and infrared data communications.

Various forms of computer readable media may be involved in carrying out one or more sequences of one or more instructions to processor 113 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 111 may receive the data on the telephone line and use an infrared transmitter to convert the data to an infrared signal. An infrared detector coupled to the bus 112 can receive the data carried in the infrared signal and place the data on the bus 112. The bus 112 carries the data to the main memory 114, from which the processor 113 retrieves and executes the instructions. The instructions received by the main memory 114 may optionally be stored on storage device 117 or 118 either before or after execution by processor 113.

The computer system 111 also includes a communication interface 123 coupled to the bus 112. The communication interface 123 provides a two-way data communication coupling to a network link 124 that is connected to, for example, a local area network (LAN) 125, or to another communications network 126 such as the Internet. For example, the communication interface 123 may be a network interface card to attach to any packet switched LAN. As another example, the communication interface 123 may be a wireless link. In any such implementation, the communication interface 123 sends and receives electrical, electromagnetic or optical signals that carry digital data streams representing various types of information.

The network link 124 typically provides data communication through one or more networks to other data devices. For example, the network link 124 may provide a connection to another computer or remotely located presentation device through a local network 125 (e.g., an 802.11-compliant wireless network) or through equipment operated by a service provider, which provides communication services through a communications network 126. In preferred embodiments, the local network 124 and the communications network 126 preferably use electrical, electromagnetic, or optical signals that carry digital data streams. The signals through the various networks and the signals on the network link 124 and through the communication interface 123, which carry the digital data to and from the computer system 111, are exemplary forms of carrier waves transporting the information. The computer system 111 can transmit and receive data, including program code, through the network(s) 125 and 126, the network link 124 and the communication interface 123. Moreover, the network link 124 may provide a connection through a LAN 125 to a mobile device 127 such as a personal digital assistant (PDA) laptop computer, or cellular telephone. The LAN communications network 125 and the communications network 126 both use electrical, electromagnetic or optical signals that carry digital data streams. The signals through the various networks and the signals on the network link 124 and through the communication interface 123, which carry the digital data to and from the system 111, are exemplary forms of carrier waves transporting the information. The processor system 111 can transmit notifications and receive data, including program code, through the network(s), the network link 124 and the communication interface 123.

Other aspects of the invention may include data transmission and Internet-related activities. See Preston Gralla, How the Internet Works, Ziff-Davis Press (1996), which is hereby incorporated by reference into this patent application. Still other aspects of the invention may utilize wireless data transmission, such as those described in U.S. Pat. Nos. 6,456,645, 5,818,328 and/or 6,208,445, all of which are hereby incorporated by reference into this patent application.

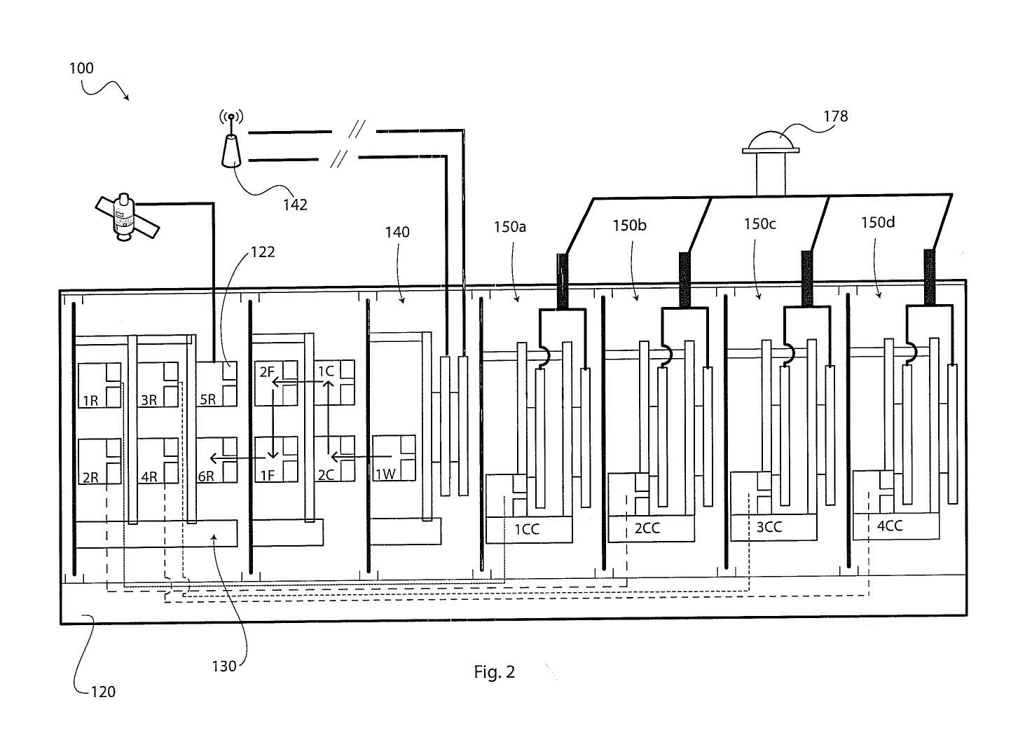

According to one exemplary embodiment, a system for optimizing mobile wireless communications 100 is disclosed. System 100 may include at least one wireless routing and network selection device 120. Routing and network selection device 120 may include an enclosure, and, disposed within the enclosure may be at least one wireless access module 150, the wireless access module being in operative communication with device 120. Embodiments of device 120 may include any desired number of wireless access modules 150. FIG. 2 shows an exemplary embodiment of a routing and network selection device 120 having four wireless modules 150a-150d in operative communication therewith.

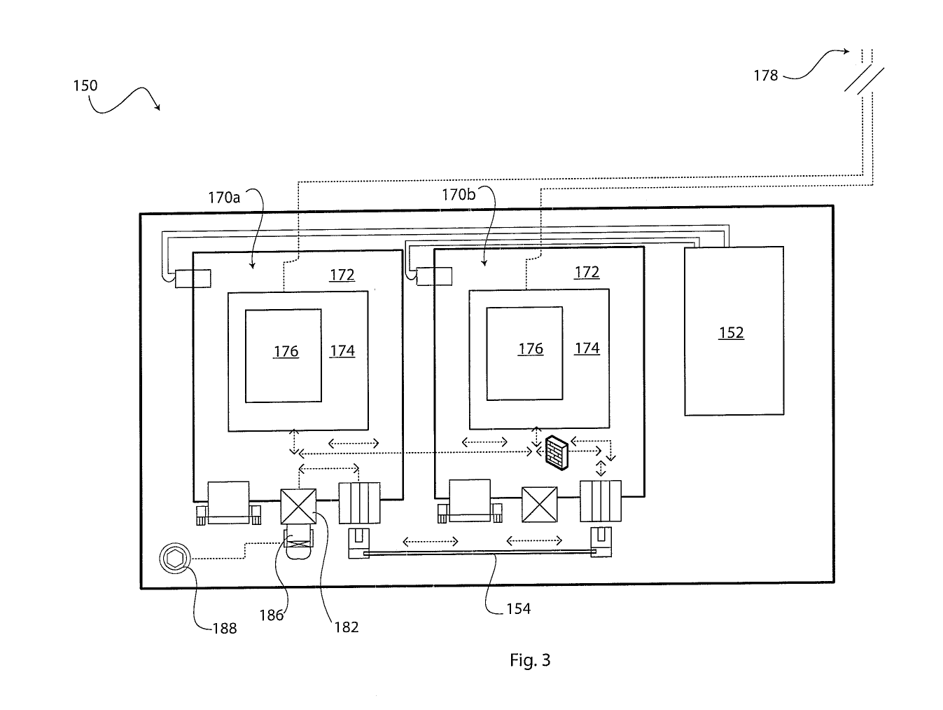

FIG. 3 shows an exemplary embodiment of a wireless module 150 for a system for optimizing mobile wireless communications 100. Wireless module 150 may include a power supply 152 and at least one pair of single-board computer (SBC) boards 170, although other types of computer systems may be used. First SBC board 170a and second SBC board 170b may each be coupled to power supply 152 and communicatively coupled to each other via coupling 154. Coupling 154 between first SBC board 170a and second SBC board 170b may be a cable, such as, for example, a CAT-6 network crossover cable, or any other communicative coupling known in the art that allows system 100 to function as described herein.

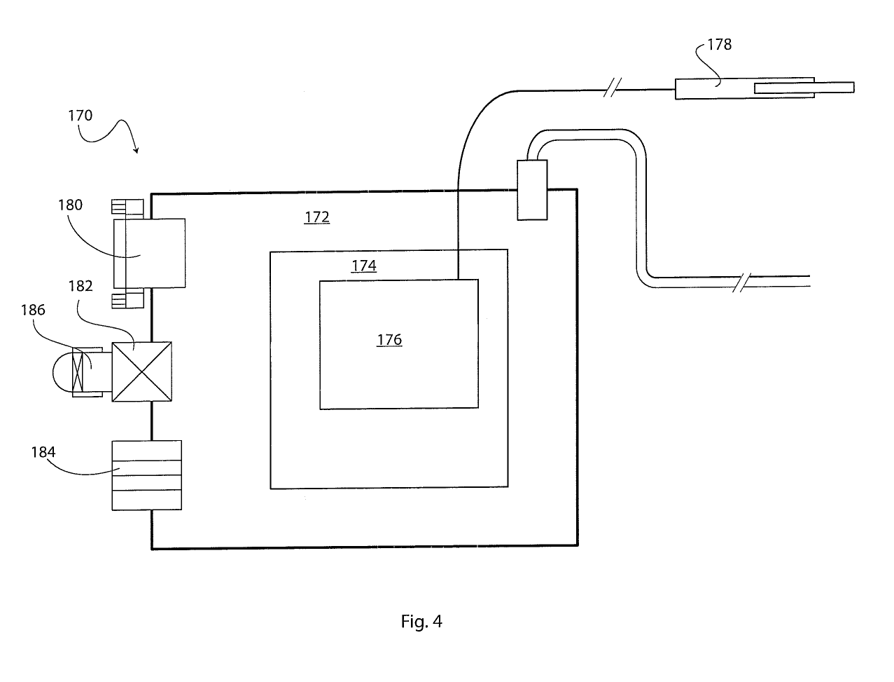

As shown in FIGS. 3-4, an SBC board 170 may include therein a main board 172, a daughterboard 174 communicatively coupled to main board 172, and a modem 176 communicatively coupled to daughterboard 174. Modem 176 may be communicatively coupled to an external antenna 178. External antenna 178 may be coupled using any connector known in the art that allows system 100 to function as described herein, for example, using an SMA connector. Communicatively coupled to main board 172 may be a plurality of communications ports. Such ports may include, for example, a serial port 180, at least one Universal Serial Bus port 182, and an Ethernet port 184. The ports 180, 182, and 184 may utilize any desired connectors compatible with the respective communications standard: for example, serial port 180 may utilize a DB-9 connector, USB port 182 may utilize a standard type-A connector, and Ethernet port 184 may utilize an RJ-45 connector. Serial port 180 may be utilized by an administrator of system 100 to program and configure the functionality of a particular SBC board. USB port 182 may be utilized to communicatively couple a 802.11-compliant network device 186 to the SBC board. Ethernet port 184 may be utilized to communicatively couple the particular SBC board to the other SBC board that is disposed on wireless module 170. It should be appreciated that SBC board 170 may utilize any other ports, connectors, or communications standards that enable system 100 to function as described herein.

Modem 176 may be configured so as to support communications with a plurality of wireless communication standards and a plurality of wireless service providers. For example, modem 176 may be configured provide for connectivity to any of a variety of networks, including CDMA2000, WCDMA, HSDPA, HSUPA and any other desired network. Exemplary mobile broadband standards include 2G, 3G and 4G broadband standards such as CDMA2000 1xEV-DO, Revisions B, A and 0, HSPA, WCDMA, and GSM/GPRS/EDGE. Still further exemplary embodiments may include hardware to communicate with any desired type or speed of network. Additionally, components of system 100, routing and network selection device 120, wireless module 150 and SBC boards 170a, 170b may be replaceable so as to facilitate ease of upgrading the components of system 100 or any constituent parts. Furthermore, certain components of system 100 may be hot-swappable or hot-pluggable, so as to facilitate replacement of such components while system 100 is in operation.

Turning back to FIG. 3, each of first and second SBC boards 170a, 170b may be configured so as to function as a separate computer system. To that end, each of boards 170a, 170b may include operating system software and any other software, firmware, or other logic or instruction sets known in the art that enable boards 170a, 170b to function as described herein. In some embodiments, boards 170a, 170b may include operating system software based on the Linux operating system. In other embodiments, boards 170a, 170b may include operating software based on the Microsoft Windows operating system or any other desired operating system. Furthermore, first board 170a and second board 170b may each include software configured for diverse functionality. First board 170a may include software such as, for example, application servers providing firewall functionality, caching server functionality, and modem interface functionality. The firewall functionality may be substantially any firewall functionality known in the art that enables system 100 to function as described herein. The caching server functionality may function so as to cache a desired number of frequently-accessed remote servers. For example, an administrator of system 100 may configure the caching server functionality to store local copies of remote websites that are most frequently accessed, or are expected to be the most frequently accessed by users of system 100, or any desired number of remote websites. In some embodiments, the caching server functionality may be capable of locally storing seven or more frequently accessed websites, thereby giving users faster access to the locally stored websites. Additionally, the caching server functionality may provide a user with a release of liability agreement when the user accesses the network of system 100. Such an agreement may include language releasing the operator of system 100 from liability for any malicious software that a user may receive while using system 100, or for any service interruptions when a signal is unavailable (such as, for example, when a vehicle having system 100 passes through a tunnel or other obstructed location).

Second board 170b may include software configured to provide network router functionality. In some exemplary embodiments, second board 170b may include an 802.11-compliant network device 186 communicatively coupled to USB port 182 thereof. Network device 186 may serve to create and maintain a local, wireless, 802.11-compliant network. In some embodiments, network device 186 may be communicatively coupled to an external antenna 188 bnso as to provide increased coverage for the local wireless network.

Turning to FIG. 2, an exemplary embodiment of a routing and network selection device 120 is shown. Device 120 may include at least one wireless access module 150. In the exemplary embodiment shown, device 120 may include four wireless modules 150a-150d. In other embodiments, any number of wireless modules may be contemplated as desired or as directed by access to a more numerous number of networks. In embodiments having two or more wireless modules, each wireless module may be configured to communicate with a particular wireless network provider. Thus, for example, a first wireless module in a device 120 having four such modules may be configured to communicate with the Verizon network, a second wireless module may be configured to communicate with the AT&T network, the third with the Sprint network, the fourth with the T-Mobile network, or any other networks desired by the operator of system 100. Additionally, routing and network selection device 120 may include the capability to communicate with a satellite-based communications network. To that end, device 120 may be communicatively coupled to a satellite modem 122, which, in turn, may be configured to communicate with any desired satellite internet service provider. Device 120 can also be communicatively coupled to any other network as desired.

Routing and network selection device 120 may be capable of comparing the communications signals received by the network modules 150a-150d included therein. To that end, device 120 may include a router 130 therein. In embodiments of routing and network selection device 120 having two or more network modules 150 included therein, each of the network modules may be coupled to router 130. In such embodiments, each of network modules 150 would not include an 802.11-compliant network device 186 coupled thereto, but may be coupled to router 130 instead. Furthermore, satellite modem 122 may also be communicatively coupled to router 130. Router 130, in turn, may be communicatively coupled to an 802.11-compliant network device 140, which may further be coupled to an external antenna 142. External antenna 142 may be an omnidirectional antenna. Network device 140 may thus create and maintain an 802.11-compliant wireless local area network.

In an exemplary method of operation of system 100, each network module 150 coupled to routing and network selection device 120 may receive a wireless communication signal from a wireless communication provider. Each network module 150 may be configured to receive the wireless communication signal from a provider different from the remaining network modules 150 coupled to device 120. In the exemplary embodiment, network modules 150a-150d may each communicate with a different wireless communications provider; thus, routing and network selection device 120 may be in communication with four or more diverse wireless providers. Routing and network selection device 120 may then compare a variety of individual factors or a combination of factors of the communications signal from each network module 150a-150d, determine which of the available signals provides an optimal connectivity based upon a desired comparison of criteria, and select that particular signal. Device 120 may then compare the selected signal to the communications signal from satellite modem 122 for quality, strength and speed, and/or other factors, determine which of the available signals provides the optimal connectivity, and select that particular signal. Subsequently, routing and network selection device 120 may use the selected communications signal and the corresponding wireless provider to provide access to the internet for the 802.11-compliant local area network that has been created using network device 140. Routing and network selection device 120 may continue to monitor factors of the communications signals from all network modules 150 and satellite modem 122. When device 120 determines that the presently selected communications signal is no longer an optimal or desired communications signal, or that connectivity has been degraded, lost or became otherwise undesirable, device 120 may dynamically switch to the communications signal that is optimal at that time. Such monitoring and dynamic signal switching may continue as long as routing and network selection device 120 is operational, thereby providing optimal connectivity for users of system 100 and reducing the likelihood of service and connectivity interruptions.

System 100 may utilize a variety of factors to select a particular wireless communication provider's signal, and may utilize any desired combination of factors. Additionally, various factors may be weighed differently by system 100 when selecting a particular wireless communications provider's signal. As a non-limiting example, such factors may include the quality and strength of the signal, and/or the speed of wireless communications that the particular signal allows. Additionally system 100 may record and track historical and geographical data regarding various available signals, and may utilize such data when selecting a particular signal, or include such data as a factor or as one of the variables in an algorithm for selecting a particular signal. As a non-limiting example, system 100 may record, track, and utilize data such as: the consistency of a particular signal with respect to time; the consistency of a signal within a particular geographical area; the geographical bounds of a particular signal, and any other desired historical or geographical data. System 100 may further utilize the above-described, as well as any additional desired factors, to predictively select a particular wireless signal. As a non-limiting example, system 100 may observe the quality strength, and/or speed of a particular signal or signals, and the fluctuations therein, over time, and select a signal that is likely to improve over a signal that is likely to degrade. As another non-limiting example, system 100 may include global positioning system (GPS) capabilities and may utilize such capabilities to record geographic locations and corresponding signal strength at that location. Consequently, when a mobile vehicle is passing through a location where one of a plurality of available signals has been recorded as degrading, and another of a plurality of available signals has been recorded as improving, system 100 may preemptively select the improving signal so as to maintain substantially uninterrupted connectivity. The particular algorithms for signal selection and the factors considered therein may be varied as desired by the operator of system 100.

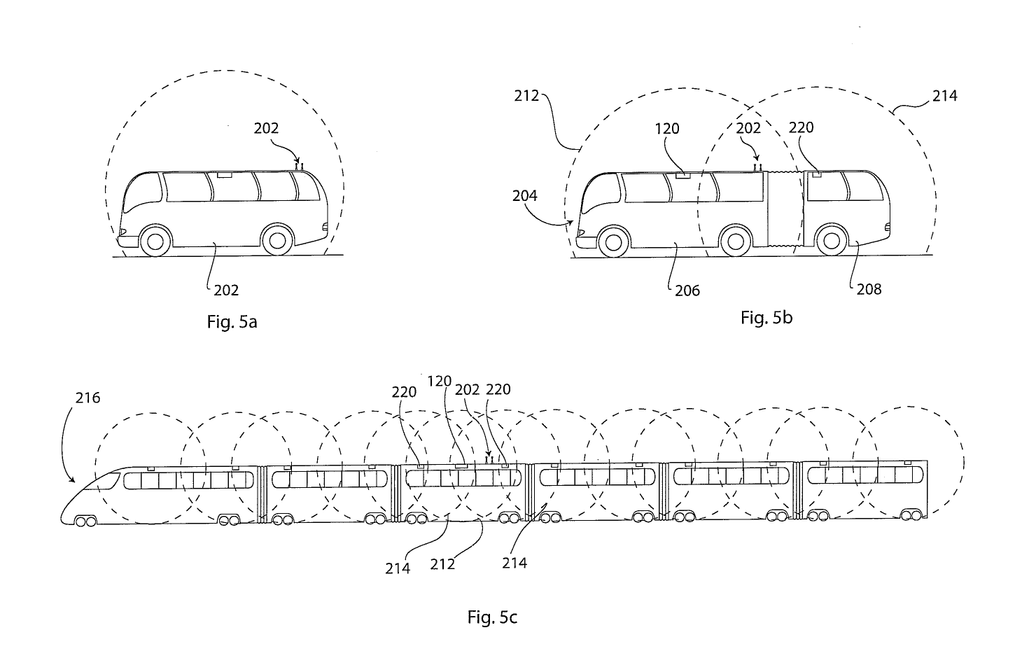

System for optimizing mobile wireless communications 100 may be installed in a mobile vehicle. Such mobile vehicles may include automobiles, limousines, buses, marine vessels, trains, or any other desired vehicle. FIG. 5a shows system 100 installed in a bus or similar vehicle 202. In smaller vehicles, an installation of system 100 may include routing and network selection device 120 mounted substantially near the center of the vehicle so as to provide a coverage area 210 having sufficient wireless local network coverage for the entirety of the vehicle. Additionally, some embodiments of system 100 may provide a wired network connection, for example by providing within the vehicle RJ-45 jacks communicatively coupled with system 100, so as to allow devices not having 802.11 capability to connect to system 100. External antennas 202 for satellite modem 122 and network modules 150 may be mounted in any desired location on the vehicle that provides optimal signal reception.

FIG. 5b shows system for optimizing mobile wireless communications 100 mounted in an articulated vehicle 204. In such an embodiment, system 100 may include routing and network selection device 120 and a repeater device 220. Repeater device 220 may function so as to extend the coverage area of the local wireless network throughout the vehicle. Repeater device 229 may further include signal boosting capabilities so as to strengthen and further enhance the wireless network signal within the coverage area of the local wireless network. Routing and network selection device 120 may be mounted substantially near the center of the main portion 206 of the articulated vehicle 204, while repeater device 220 may be mounted in the second portion 208 of the articulated vehicle 204. Repeater device 220 may be positioned so as to provide sufficient wireless local network coverage for the entirety of the vehicle and such that there is sufficient overlap between the coverage area 212 of routing and network selection device 129 and coverage area 214 of repeater device 220. Furthermore, devices 120, 220 may be provided with omnidirectional antennas for creating the local wireless network. The omnidirectional antennas may reduce the likelihood of any breaks in coverage when articulated vehicle 204 is turning and the two cars of the articulated vehicle are not coaxial to each other. Additionally, some embodiments of system 100 may provide a wired network connection, for example by providing within the vehicle RJ-45 jacks communicatively coupled with system 100, so as to allow devices not having 802.11 capability to connect to system 100. External antennas 202 for satellite modem 122 and network modules 150 may be mounted in any desired location on the vehicle that provides optimal signal reception.

FIG. 5c shows system for optimizing mobile wireless communications 100 mounted in an multiple-car articulated vehicle 216, for example, a train. In such an embodiment, system 100 may include routing and network selection device 120 and a plurality of repeater devices 220. Repeater devices 220 may function so as to extend the coverage area of the local wireless network throughout the vehicle. Repeater devices 220 may further include signal boosting capabilities so as to strengthen and further enhance the wireless network signal within the coverage area of the local wireless network. Routing and network selection device 120 may be mounted substantially near the center of a desired car of the multiple-car vehicle 216, for example the lounge car, dining car, or any car located substantially near the center portion of the multiple car vehicle. Additionally, each car may have repeater devices 220 positioned substantially near the front portion and rear portion of the car. Such positioning increases the likelihood of sufficient overlap between the coverage areas 214 of repeater devices 220, thereby providing uninterrupted local wireless network coverage for vehicle 216. Furthermore, devices 120, 220 may be provided with omnidirectional antennas for creating the local wireless network. The omnidirectional antennas may reduce the likelihood of any breaks in coverage when multiple-car vehicle 216 is traveling around a curve such that the cars of the multiple-car vehicle are not coaxial to each other. Additionally, some embodiments of system 100 may provide a wired network connection, for example by providing within the vehicle RJ-45 jacks communicatively coupled with system 100, so as to allow devices not having 802.11 capability to connect to system 100. External antennas 202 for satellite modem 122 and network modules 150 may be mounted in any desired location on the vehicle that provides optimal signal reception.

Certain high-capacity vehicles, for example trains, may potentially present a large quantity of users that may be connected to system 100. In such cases, communications speeds may be limited by the throughput of a wireless communications signal to a single selected provider. Therefore, some embodiments of system 100 may include the capability to select a plurality of wireless communications providers. The wireless communications providers may be selected substantially based on the methods and algorithms described above. However, rather than selecting a single optimal signal, system 100 may select, for example, an optimal signal and the next-most-optimal signal. System 100 may then utilize one of such signals for a local wireless network that is created and maintained over a first portion of the vehicle, and may utilize the other of such signals for a local wireless network that is created and maintained over a second portion of the vehicle. System 100 may thus provide users with optimal communications speeds by utilizing a plurality of wireless network providers' signals.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for optimizing mobile wireless communications, comprising:
receiving a first communications signal from a first wireless network provider;
receiving at least one additional communications signal from at least one additional network provider;
executing a comparison between the first communication signal and the at least one additional communications signal;
selecting one of the first communication signal and the at least one additional communications signal based on the comparison; and
establishing a communications link to the selected signal.

2. The method of claim 1, further comprising:
monitoring the selected signal;
comparing the selected signal to at least one additional communications signal from at least one additional network provider;
executing a comparison between the selected communication signal and the at least one additional communications signal; and
establishing a communications link to one of the selected signal and the at least one additional communications signal.

3. The method of claim 1, wherein executing a comparison between the first communication signal and the at least one additional communications signal further comprises:
comparing the strength of the first communications signal to the strength of the at least one additional communications signal.

4. The method of claim 1, wherein executing a comparison between the first communication signal and the at least one additional communications signal further comprises:
comparing the communications speed of the first communications signal to the communications speed of the at least one additional communications signal.

5. The method of claim 1, wherein executing a comparison between the first communication signal and the at least one additional communications signal further comprises:
comparing the quality of the first communications signal to the quality of the at least one additional communications signal.

6. The method of claim 1, wherein executing a comparison between the first communication signal and the at least one additional communications signal further comprises:
comparing the consistency with respect to time of the first communications signal to the consistency with respect to time of the at least one additional communications signal.

7. The method of claim 1, wherein executing a comparison between the first communication signal and the at least one additional communications signal further comprises:
comparing the consistency with respect to geographical area of the first communications signal to the consistency with respect to geographical area of the at least one additional communications signal.

8. The method of claim 1, wherein executing a comparison between the first communication signal and the at least one additional communications signal further comprises:
comparing the geographical bounds of the first communications signal to the geographical bounds of the at least one additional communications signal.

9. The method of claim 1, further comprising:
establishing a local area network; and
utilizing the selected signal to communicatively couple the local area network to a wireless network provider.

10. The method of claim 9, wherein the local area network is an IEEE 802.11-compliant network.

11. The method of claim 10, further comprising utilizing at least one wireless repeater to extend the range of the IEEE 802.11-compliant network.

12. The method of claim 10, further comprising boosting the signal of the IEEE 802.11-compliant network.

13. A system for optimizing mobile wireless communications, comprising:
a processor;
a routing and network selection device;
at least one communications device coupled to the routing and network selection device, the at least one communications device capable of connecting to a wireless network provider and receiving a wireless communications signal from the wireless network provider; and
at least one antenna coupled to the routing and network selection device, the at least one antenna capable of creating and maintaining a local area network.

14. The system of claim 13, further comprising:
at least two communications devices coupled to the routing and network selection device, the at least two communications devices capable of connecting to at least two wireless network providers and receiving at least two wireless communications signal from the at least two wireless network providers; and
logic adapted to execute a comparison between the at least two wireless communications signals, and to select one of the at least two wireless communications signals based on the comparison.

15. The system of claim 14, wherein the local area network is an IEEE 802.11-compliant network.

16. The system of claim 14, wherein the antenna is an omnidirectional antenna.

17. The system of claim 15, further comprising at least one wireless repeater adapted to extend the range of the wireless network.

18. The system of claim 14, wherein the comparison further comprises a comparison of the strength of the wireless signals.

19. The system of claim 14, wherein the comparison further comprises a comparison of the quality of the wireless signals.

20. The system of claim 14, wherein the comparison further comprises a comparison of the communications speed of the wireless signals.

21. The system of claim 14, wherein the comparison further comprises a comparison of the consistency with respect to time of the wireless signals.

22. The system of claim 14, wherein the comparison further comprises a comparison of the consistency with respect to geographical area of the wireless signals.

23. The system of claim 14, wherein the comparison further comprises a comparison of the geographical bounds of the wireless signals.

24. The system of claim 13, wherein the system is adapted for installation in a vehicle.

25. The system of claim 24, wherein the vehicle is an articulated vehicle.

26. The system of claim 24, wherein the vehicle is a train.
